(19) United States
(12) Patent Application Publication
(10) Pub. No.: US 2025/0349225 A1
(43) Pub. Date: Nov. 13, 2025

(54) Method for Generating and Displaying Proportional, Textless Musical Instrument Layouts for Educational Purposes

(71) Applicant: William Campbell Hornby, Pflugerville, TX (US)

(72) Inventor: William Campbell Hornby, Pflugerville, TX (US)

(21) Appl. No.: 18/660,265

(22) Filed: May 10, 2024

(51) Int. Cl. G09B 15/00; G09B 15/02

(52) U.S. Cl. CPC G09B 15/003; G09B 15/023

(57) ABSTRACT

The present invention provides a computer-implemented method for creating a musical educational aid. The method includes selecting a physical musical instrument and accessing a set of dimensions associated with the selected musical instrument. Based on these dimensions, a textless and proportionally accurate representation layout of the selected musical instrument is generated. The method further includes selecting at least one musical scale or chord and placing a subset of musical note labels on the generated layout. These labels correspond to positions for finger placement for each of the notes in the selected musical scale or chord. This invention facilitates the visual learning of musical instruments by providing clear and precise visual representations without the need for textual explanations.

### FIELD OF INVENTION

The present invention relates generally to the field of music education technology, specifically to a computer-implemented method for generating and displaying digital, visual representations of musical instrument layouts. These layouts are designed for educational purposes to facilitate the learning of musical scales and chords across various instruments without the need for textual instruction.

### BACKGROUND

In the realm of musical education, traditional methods such as tablature, chord shapes, and standard notation have long been staples. However, these methods often require a substantial understanding of music theory and are predominantly text-based, posing significant hurdles for beginners. Specifically, tablature and chord shapes, which primarily utilize numerical and dot representations, lack intuitive visual cues that align with the physical positioning of a player's hands and fingers on the instrument. This disconnection can impede the learning process, making it challenging for students to translate visual or textual information into physical actions. Additionally, traditional stave notation, while comprehensive, often overwhelms novices with its complexity, discouraging initial exploration and practice.

Furthermore, existing digital and printed resources for musical education tend to focus heavily on theoretical explanations or require users to follow dynamic visual aids such as bouncing balls or scrolling notes. These methods can distract from the actual mechanics of playing an instrument. They often do not accommodate multi-instrument learning platforms, forcing learners to seek out instrument-specific resources that may not offer consistent teaching methodologies across different musical instruments. Moreover, the orientation and layout of such educational materials rarely consider the player's perspective, which is crucial for instruments like the guitar or ukulele where the player's view of the instrument's fretboard is a top-down perspective during actual play.

The digital representation of musical instruments for educational purposes, particularly those that cater to a variety of instruments while maintaining a consistent learning approach, remains insufficiently explored in current offerings. Existing digital layouts often fail to provide a real-time, intuitive visual guide that can be used in conjunction with the actual playing of the instrument. They are typically not customizable to accommodate various musical scales or chords, nor do they adapt to the specific dimensions and layouts of different musical instruments.

This lack of intuitive, practical, and versatile educational tools in the music learning landscape creates a significant gap for learners who seek a more straightforward, visually guided, and practical approach to understanding and mastering musical instruments. The necessity for a solution that addresses these pedagogical and practical limitations has led to the development of innovative methods and systems in the digital visualization of musical instrument layouts, specifically tailored to enhance the educational experience for learners across multiple instruments.

It is within this context that the present invention is provided.

### SUMMARY

The present invention generally relates to a computer-implemented method for creating a musical educational aid. The method involves selecting a physical musical instrument, accessing dimensions associated with the instrument, and generating a textless, proportionally accurate representation layout of the instrument. It further includes selecting at least one musical scale or chord and placing musical note labels on the layout, corresponding to the positions for finger placement for each of the notes in the selected scale. This approach provides a clear, intuitive means for learners to visually grasp the placement of notes on an instrument, facilitating easier learning without reliance on textual explanations.

In some embodiments, the method includes generating a layout displaying the full set of notes for the musical instrument and positioning this layout adjacent to the layout of the selected musical scales or chords. This configuration allows learners to see the complete note range in context with specific scales or chords, enhancing their understanding of the instrument's layout.

In some embodiments, the layouts for the musical scales or chords and the full set of notes layout are configured to be printed as a single sheet. This feature aids in convenient reference and practice, allowing learners to have all necessary information on one physical sheet during practice sessions.

In some embodiments, the representation layout includes proportionally accurate representations of specific features of the musical instrument, such as strings, frets, or keys, with variations in line thickness to represent string thickness for stringed instruments. This detailed depiction helps in providing a more realistic visual representation, aiding users in better understanding the physical characteristics of the instrument

In some embodiments, the method allows for the use of computer editing software to manually adjust the placement of musical note labels on the generated layout. This flexibility facilitates customizations to meet specific educational needs or preferences.

In some embodiments, for stringed instruments, the representation layout is oriented facing downward, displaying labels for the note played as well as the string thickness. This orientation mirrors the actual user view during playing, which can be more intuitive and user-friendly for learners.

In some embodiments, the method allows choosing multiple musical scales or chords for the same instrument and generating adjacent layouts for each selected scale or chord on the same representation layout. This enables a comprehensive view of different musical modalities in one glance, enhancing learning efficiency.

In some embodiments, visual markers are added on the generated layout to indicate optimal hand positions or movements required to play the selected musical scale or chord. These visual cues can guide learners in correct finger placement and technique, improving skill acquisition.

In some embodiments, the subset of musical note labels includes enharmonic equivalents of notes where applicable, providing alternative fingering positions on the generated layout. This feature accommodates various playing styles and preferences, enhancing the versatility of the educational aid.

In some embodiments, the method incorporates color-coded elements into the generated layout, where different colors represent different types of musical notes or intervals within the selected musical scale or chord. Color coding can simplify the identification of notes and intervals, making the layout more accessible and easier to understand.

In some embodiments, the selected musical scale or chord includes both a major and a minor scale, and layouts for both scales are generated on the same or separate sheets. This allows learners to explore major and minor tonalities side-by-side, promoting a deeper understanding of music theory and its practical application.

In some embodiments, the generated layout is configured for digital display on electronic devices in addition to being printable. This dual functionality offers flexibility in how the educational material can be utilized, catering to both digital and traditional learning environments.

In some embodiments, the method further includes an animation feature within the software, which enables the sequential highlighting of musical note labels on the generated layout. This visual cue represents the playing sequence of any selected musical scale. By animating the labels from the start to the end of the scale, the feature assists learners in visualizing the temporal and spatial progression of scale playing, facilitating a better understanding and memorization of musical scales.

This may involve highlighting specific subsets of musical note labels that correspond to a selected chord on the generated digital layout, or illuminating musical note labels in a sequence that mimics the actual playing of musical scales or chords. This allows learners to visually distinguish and focus on the essential notes that make up the chord or scale, simplifying the learning process for complex chord structures and enhancing the accuracy of finger placement on the instrument.

### BRIEF DESCRIPTION OF THE DRAWINGS

Various embodiments of the invention are disclosed in the following detailed description and accompanying drawings.

FIG. 1 illustrates an example flowchart depicting the steps involved in a computer-implemented method for creating a musical educational aid.

FIG. 2A illustrates an example detailed diagram of the mandolin fretboard dimensions, providing essential measurements for creating an accurate digital representation.

FIG. 2B illustrates an example of a blank mandolin template prepared for the addition of musical note labels.

FIG. 2C illustrates an example of a completed mandolin layout with musical note labels placed for both the C major and C minor scales.

FIG. 3 illustrates an example of an alternative layout with two piano keyboards, showing the D major scale on the top and the D minor scale on the bottom.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “first,” “second,” and the like are used to distinguish different elements or features, but these elements or features should not be limited by these terms. A first element or feature described can be referred to as a second element or feature and vice versa without departing from the teachings of the present disclosure.

For the purposes of this patent application, the term “computer-implemented method” refers to a method executed partially or entirely using computer technology. The method may be performed using standard computing devices including, but not limited to, personal computers, laptops, tablets, and specialized computing hardware. Software applications used to carry out the method may include graphic design software such as Adobe Illustrator, CorelDRAW, or any other suitable program that allows for the manipulation and creation of digital images and layouts.

The term “musical educational aid” is defined as any tool or resource, digital or otherwise, intended to facilitate the learning of musical instruments or music theory. This includes visual aids that show the placement of notes, scales, or chords on a simulated representation of a musical instrument.

The term “physical musical instrument” refers to any traditional musical instrument for which the educational aid is being created, including but not limited to stringed instruments like guitars and violins, wind instruments like flutes and saxophones, keyboard instruments like pianos and synthesizers, and percussion instruments like drums and xylophones.

The term “proportionally accurate representation” includes any digital or graphical representation of a musical instrument that maintains the relative dimensions and spatial relationships true to the physical counterpart of the instrument. This accuracy is crucial for ensuring that the educational aid is as effective and realistic as possible.

The term “musical scale or chord” refers to a sequence of musical notes that are played in a particular order, representing a scale or a chord that a musician might use in practice or performance. The choice of scale or chord can vary widely depending on the musical piece or exercise being learned.

The term “musical note labels” refers to visual markers placed on the representation layout that indicate where a musician would place their fingers or make contact with the instrument to produce specific musical notes. These labels are crucial for guiding the user in playing the instrument and understanding the layout of notes across the instrument's interface.

### DESCRIPTION OF DRAWINGS

The present invention pertains to a computer-implemented method for creating a musical educational aid designed to assist in the learning of musical instruments. This method simplifies the complex process of music education by providing a digital, visual representation of musical instrument layouts that are both textless and proportionally accurate. This innovative approach allows individuals to visually connect with the instrument's layout, fostering a more intuitive learning experience.

One of the significant benefits of this invention is its ability to transform the traditional learning method, which often relies heavily on textual descriptions and theoretical knowledge, into a more accessible and visually-oriented process. By eliminating text and focusing solely on visual representations, the invention caters to a wide range of learning styles, particularly benefiting visual learners. It allows learners to concentrate on the physical aspects of playing an instrument without the distraction of interpreting textual information.

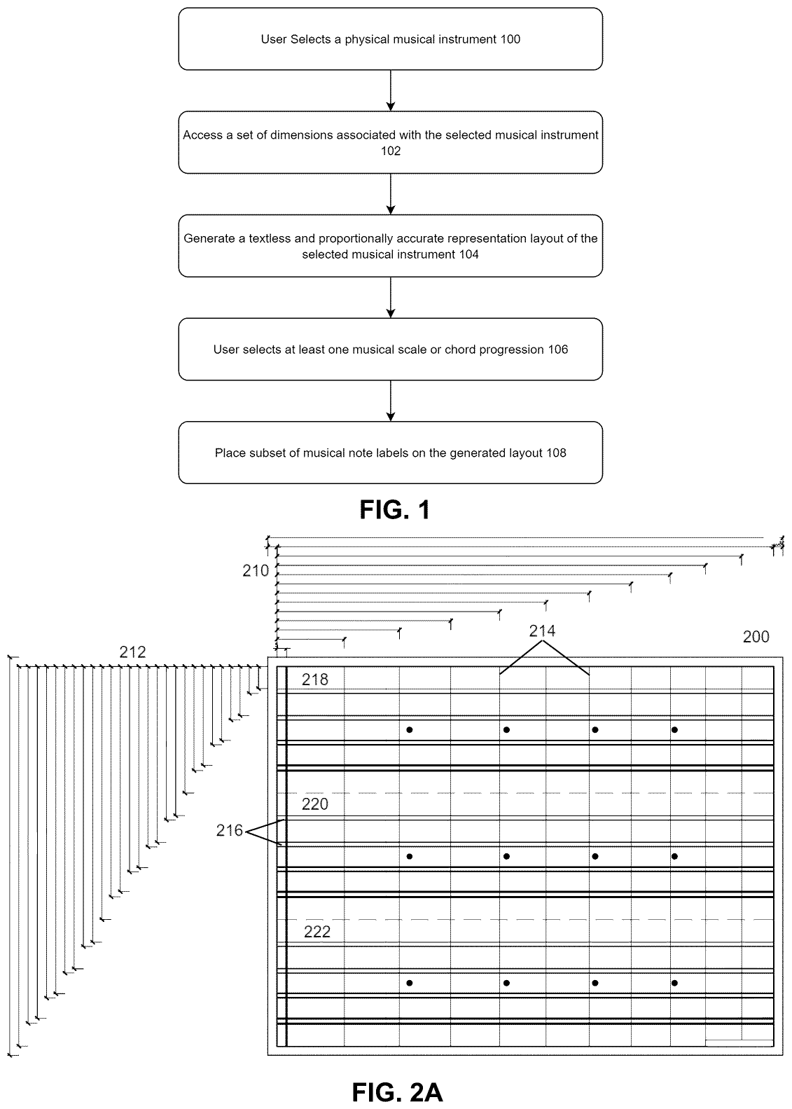

Referring to FIG. 1, an example flowchart illustrates the computer-implemented method for creating a musical educational aid. The method begins with the step of selecting a physical musical instrument 100, where a user chooses a specific instrument for which the educational aid is to be created. Common examples of instruments selected could include a guitar, piano, or violin, depending on the user's educational focus.

Following the selection of the instrument, the method involves accessing a set of dimensions associated with the selected musical instrument 102. This step may utilize a digital database or manual input where dimensions such as the length, width, and specific component measurements (e.g., fret spacing for guitars or key width for pianos) are retrieved. These dimensions are crucial for ensuring that the digital representation accurately reflects the real-world physical characteristics of the instrument.

The next step in the flowchart is generating, based on the accessed dimensions, a textless and proportionally accurate representation layout of the selected musical instrument 104. Software tools like Adobe Illustrator or AutoCAD could be used here to create the layout. This layout serves as a visual template that depicts the instrument without any textual descriptions, focusing solely on the visual aspects.

Subsequently, the user selects at least one musical scale or chord 106. This selection can be made from a predefined list in the software or entered manually by the user, depending on the educational goals. The selected musical content dictates the notes and chords that will be displayed on the instrument's layout.

The final step shown in the flowchart is placing a subset of musical note labels on the generated layout 108. These labels correspond to positions for finger placement for each of the notes in the selected musical scale or chord. The placement of these labels can be adjusted manually within the software to ensure they are located at the correct string, fret, or key on the instrument layout. This step transforms the layout into a practical educational aid that visually guides the user in learning how to play the selected scales on the instrument.

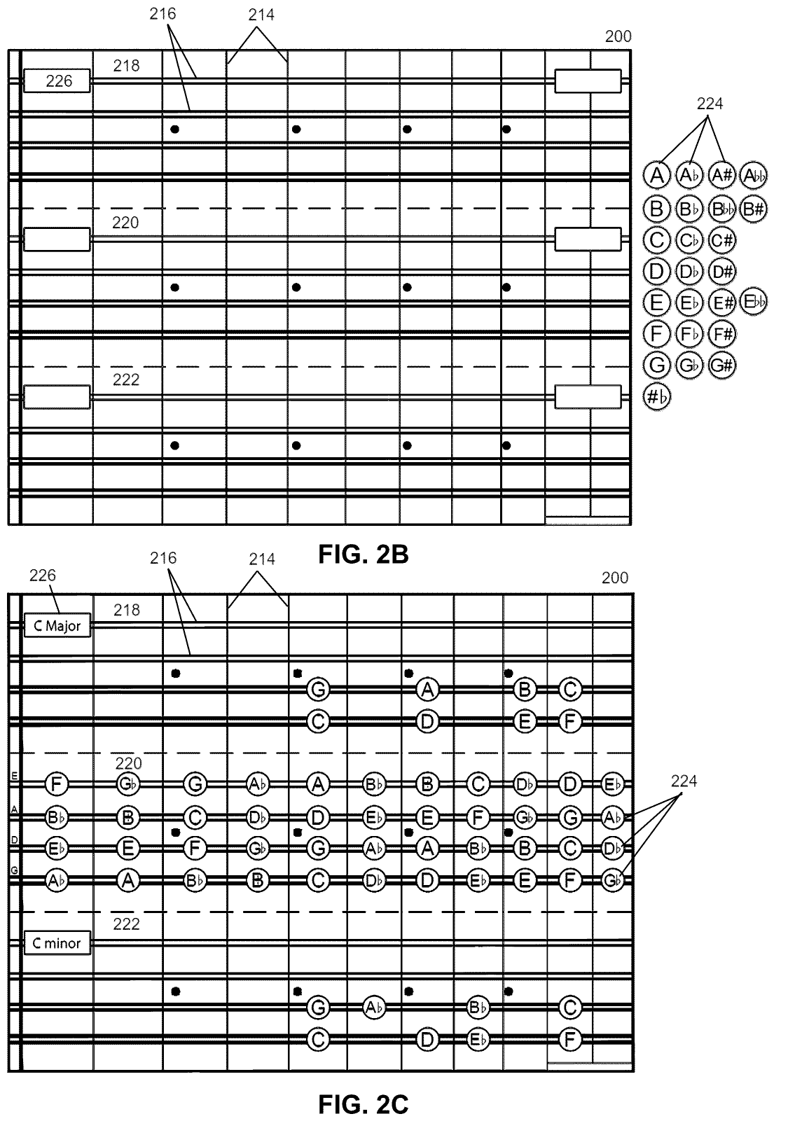

Referring to FIGS. 2A-2C, the sequence of figures represents the stages of creating a digital musical educational aid for a mandolin.

FIG. 2A details the step of applying the mandolin fretboard dimensions for an accurate digital representation of the layout 200. The necessary fret spacing measurements 210 are shown for outlining the positioning of frets 214 on the mandolin. String spacing measurements 212 help define the space between strings 216, which are visually represented with thicker lines towards the bottom to represent the physical string thickness variation. The diagram shows three separate fretboards, indicated by reference numerals 218, 220, and 222, allowing a single layout to illustrate different segments or views of the mandolin fretboard.

FIG. 2B transitions from the dimensional data to a blank mandolin template. This image is directly tied to the generating step 104 in FIG. 1, where the accessed dimensions from FIG. 2A are utilized to draft a textless and proportionally correct layout of the mandolin fretboard. This step typically employs graphic design software such as Adobe Illustrator, which facilitates precision and adjustability in the layout creation. Additionally, a set of musical labels 224 are shown to the side. These labels are positioned adjacent to the fretboard, prepared for placement but not yet assigned to specific locations on the fretboard. The fretboards are each also provided with label spaces 226 for indicating what the fretboard represents (i.e. what scale or chord).

FIG. 2C presents the completed mandolin layout for both the C major and C minor scales, indicated within label spaces 226, and with the middle fretboard having the entirety of the mandolin's available musical notes indicated on it. This arrangement visually communicates in an intuitive way where on the fretboard the musician should place their fingers to produce the desired musical notes for the C major scale, C minor scale, and in general, effectively using the layout to teach the positions for playing specific musical scales.

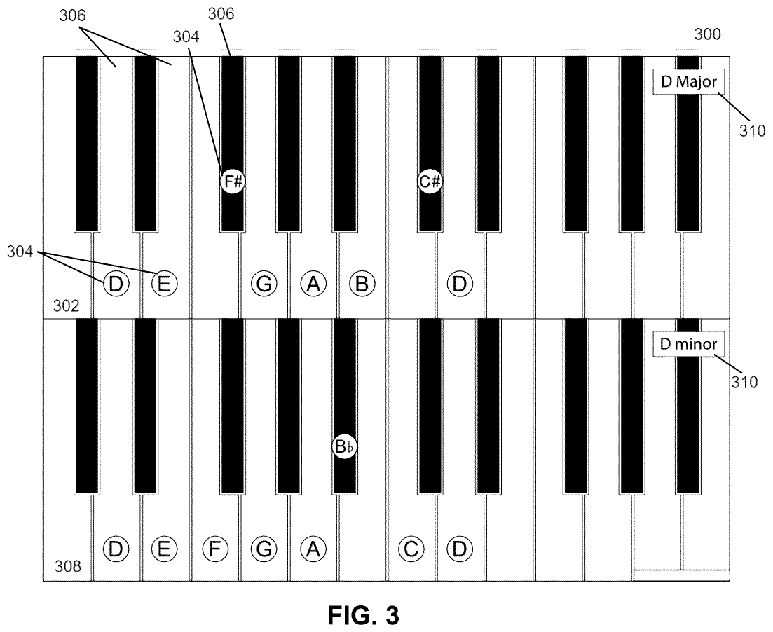

FIG. 3 presents an alternative example layout 300 featuring two piano keyboards, showcasing how the method can be adapted for keyboard instruments.

The top piano keyboard 302 in FIG. 3 is labelled with a set of note labels 304 for the D major scale. These labels are strategically placed on the corresponding keys 306 to visually demonstrate the correct key positions for playing the D major scale.

The bottom piano keyboard 308 in FIG. 3 is similarly arranged but with note labels 304 for the D minor scale 304. This layout serves a similar educational purpose, allowing learners to visually compare the minor scale with the major scale on the same instrument.

Similarly to FIGS. 2B and 2C, labels 310 are provided to indicate the musical scale or chord being represented.

### Controller/Processor Components

The disclosed method may be carried out on any suitable computer device. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method and educational aid layouts of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for creating a musical educational aid, comprising:
selecting a physical musical instrument;
accessing a set of dimensions associated with the selected musical instrument;
generating, based on the accessed dimensions, a textless and proportionally accurate representation layout of the selected musical instrument;
selecting at least one musical scale or chord; and
placing a subset of musical note labels on the generated layout, wherein the labels correspond to positions for finger placement for each of the notes in the selected musical scale or chord.

2. The method of claim 1, further comprising generating a layout displaying the full set of notes for the selected musical instrument, and positioning said layout adjacent to the layout of the one or more selected musical scales or chords.

3. The method of claim 2, wherein the layouts for the musical scales or chords and the full set of notes layout are configured to be printed as a single sheet.

4. The method of claim 1, wherein the representation layout further includes proportionally accurate representations of specific features of the musical instrument, such as strings, frets, or keys, with variations in line thickness to represent string thickness for stringed instruments.

5. The method of claim 1, further comprising the step of utilizing a computer editing software to manually adjust the placement of musical note labels on the generated layout.

6. The method of claim 1, wherein the selected physical musical instrument is a stringed instrument, and the representation layout includes an orientation facing downward, displaying labels for the note played as well as the string thickness.

7. The method of claim 1, wherein the selecting step includes choosing multiple musical scales or chords for the same instrument, and generating adjacent layouts for each selected scale on the same representation layout.

8. The method of claim 1, further comprising adding visual markers on the generated layout to indicate optimal hand positions or movements required to play the selected musical scale or chord.

9. The method of claim 1, wherein the subset of musical note labels includes enharmonic equivalents of notes where applicable, providing alternative fingering positions on the generated layout.

10. The method of claim 1, further comprising the step of incorporating color-coded elements into the generated layout, where different colors represent different types of musical notes or intervals within the selected musical scale or chord.

11. The method of claim 1, wherein the selected musical scale or chord includes both a major and a minor scale, and layouts for both scales are generated on the same or separate sheets.

12. The method of claim 1, where the generated layout is configured for digital display on electronic devices in addition to being printable.

13. The method of claim 1, further comprising a feature in the software that animates the musical note labels on the generated layout, sequentially highlighting each label to visually represent the playing sequence of a selected musical scale.

14. The method of claim 1, further comprising the step of highlighting a subset of musical note labels on the generated digital layout, which correspond to a selected chord.

15. The method of claim 1, wherein the generated layout includes an animation mode, which can be activated to display the playing of musical scales or chords through a sequence of illuminated musical note labels, enhancing the interactive learning experience.
